(19) United States
(12) Patent Application Publication
(10) Pub. No.: US 2007/0230615 A1
(43) Pub. Date: Oct. 4, 2007

(54) Reduced distortion amplifier

(76) Inventors: Stewart S. Taylor, Beaverton, OR (US); Georgios Palaskas, Portland, OR (US)

Correspondence Address: LeMoine Patent Service, PLLC;C/O PortfolioIP, P.O. Box 52050, Minneapolis, MN, 55402, US

(21) Appl. No.: 11/394,511

(22) Filed: Mar. 31, 2006

(51) Int. Cl. H04L 25/49; H04L 27/20

(52) U.S. Cl. 375/297; 375/308

(57) ABSTRACT

AM/AM distortion is reduced in an amplifier. A lookup table with amplitude correction data is indexed using information derived from an amplitude of a baseband signal. The amplitude correction data is applied as gain control to a variable gain stage.

### FIELD

The present invention relates generally to amplifier circuits, and more specifically to amplifier circuits with reduced distortion.

### BACKGROUND

Amplifiers typically receive an input signal and produce an output signal of larger amplitude. Amplifiers may not only amplify a signal, but they may also distort the signal, which may be undesirable. For example, an amplifier may have gain variations as a function of output signal power. This type of variation results in what is typically referred to as amplitude modulation (AM) to amplitude modulation (AM), or “AM/AM,” distortion.

AM/AM distortion may have many causes. For example, AM/AM distortion may result from gain expansion due to class AB biasing and may also result from gain compression when transistors enter the low gain region (triode region for field effect transistors, saturation region for bipolar transistors). AM/AM distortion degrades linearity, which in turn increases adjacent channel power and alternate channel power (spectral re-growth), and increases error vector magnitude (EVM).

### BRIEF DESCRIPTION OF THE DRAWINGS

FIG. 1 shows an amplifier circuit in accordance with various embodiments of the present invention;

FIG. 2 shows an amplifier circuit with multiplying digital-to-analog converters;

FIG. 3 shows an amplifier circuit with variable gain stages in a baseband signal path;

FIG. 4 shows an amplifier circuit having a variable gain radio frequency (RF) amplifier;

FIG. 5 shows a variable gain amplifier;

FIG. 6 shows a flowchart in accordance with various embodiments of the present invention; and

FIG. 7 shows a diagram of an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

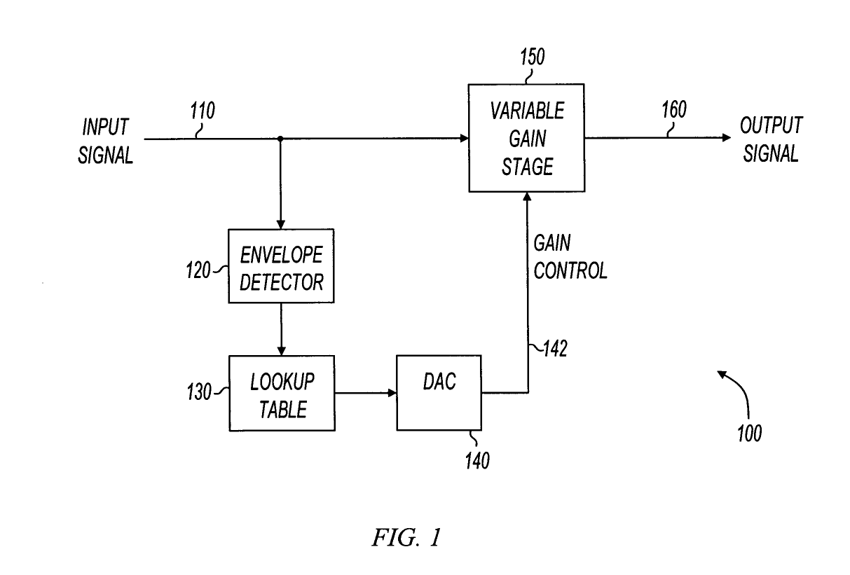

FIG. 1 shows an amplifier circuit in accordance with various embodiments of the present invention. Amplifier circuit 100 includes variable gain stage 150, envelope detector 120, lookup table 130, and digital-to-analog converter (DAC) 140. Amplifier circuit 100 amplifies an input signal on node 110 using variable gain stage 150, and drives an output signal on node 160. Variable gain stage 150 receives a gain control signal on node 142. Variable gain stage 150 changes the amount of amplification provided based on the value of the gain control signal.

Envelope detector 120 detects the amplitude of the input signal on node 110, and provides the amplitude information to lookup table 130. Lookup table 130 provides a digital gain correction value to DAC 140, which in turn provides the gain control signal on node 142.

Lookup table 130 includes correction factors to correct for any nonlinearities in variable gain stage 150. For example, if at any given input power variable gain stage 150 exhibits gain compression, lookup table 130 may provide gain control information to increase the gain and counteract the effects of the gain compression. Further, if at any given input power variable gain stage 150 provides an increased gain, lookup table 130 may provide gain control information to reduce the gain of variable gain stage 150. By counteracting gain variations in variable gain stage 150, AM/AM distortion may be reduced.

The various elements shown in FIG. 1 may be a combination of digital and analog components. For example, the input signal on node 110 may be a digital signal or an analog signal. For digital input signals, envelope detector 140 may be implemented as a digital amplitude detector. For analog input signals, envelope detector 120 may include an analog amplitude detector and an analog-to-digital converter (ADC). Further, in embodiments where the input signal includes in-phase (I) and quadrature (Q) components, envelope detector 120 may compute the amplitude from the in-phase and quadrature components.

Variable gain stage 150 may receive an analog input signal and produce an amplified analog output signal, where the amount of amplification is influenced by the gain control signal on node 142. Variable gain stage 150 may also receive a digital input signal and produce an amplified analog output signal. In some embodiments, variable gain stage 150 includes a DAC to convert the input signal to an analog signal. In these embodiments, the gain control signal on node 142 may influence a gain of the DAC, an analog gain stage following the DAC, or a combination of the two.

Lookup table 130 may be any type of component that provides gain control information in response to receiving amplitude information. For example, lookup table 130 may be a memory device or a register file. Digital-to-analog converter 140 receives a digital gain correction value from lookup table 130, and provides an analog gain control signal to variable gain stage 150.

In some embodiments, additional amplifiers may amplify the output signal on node 160. In these embodiments, the gain control signal modifying the gain of variable gain stage 150 may be calibrated such that the entire amplifier chain is linearized. For example, the amplifier chain may include variable gain stage 150 and one or more amplifiers following variable gain stage 150, and the entire amplifier chain may exhibit a particular amplitude distortion characteristic when no gain control is provided. The information stored in lookup table 130 may represent gain control information calibrated to reduce the amplitude distortion of the entire amplifier chain.

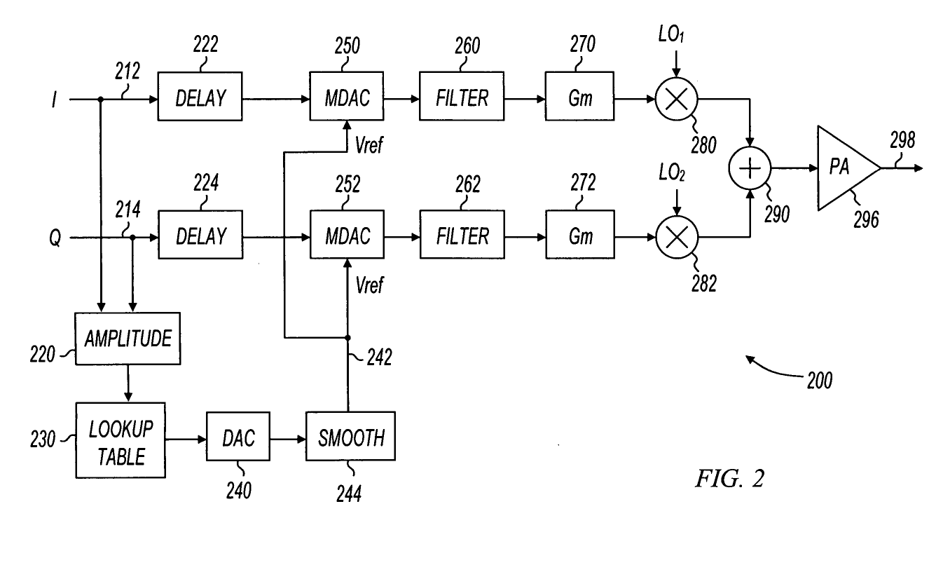

FIG. 2 shows an amplifier circuit with multiplying digital-to-analog converters. Circuit 200 includes amplitude function 220, lookup table 230, DAC 240, smoothing filter 244, delay elements 222 and 224, multiplying digital-to-analog converters (MDAC) 250 and 252, filters 260 and 262, transconductance devices 270 and 272, mixers 280 and 282, signal summer 290, and power amplifier 296. Transconductance devices 270 and 272 may be part of mixers 280 and 282, but for clarity are shown separately in FIG. 2.

In operation, circuit 200 receives in-phase (I) and quadrature (Q) digital baseband data on nodes 212 and 214, and produces an amplified radio frequency (RF) signal on output node 298. After passing through delay elements 222 and 224, the digital baseband signals are converted to analog signals in MDACs 250 and 252. The multiplying DAC is one in which the output signal is the product of the digital input and the reference signal. As shown in FIG. 2, the reference signal (V_{REF}) provided to MDACs 250 and 252 is generated using gain correction information from lookup table 230.

Filter 260 filters the analog I baseband signal, and filter 262 filters the analog Q baseband signal. Transconductors 270 and 272 convert the voltages of the analog baseband signals to currents, and mixers 280 and 282 up-convert the baseband I and Q signals to RF. Signal summer 290 combines the up-converted I and Q signals, and power amplifier 296 amplifies the RF signal and provides an output signal on node 298.

Amplitude function 220 operates similarly to envelope detector 120 (FIG. 1). For example, amplitude function 220 may determine the amplitude of the baseband input signal. Further, in some embodiments, amplitude function 220 may perform differently than envelope detector 120. For example, amplitude function 220 may approximate the amplitude to simplify the hardware design. Also for example, amplitude function 220 may simply drop the least significant bits of the digital baseband samples, and pass the most significant bits to lookup table 230. In some embodiments, amplitude function 220 is omitted, and the digital baseband samples are used directly to index into lookup table 230. The various embodiments of the present invention are not limited by the function or implementation of amplitude function 220.

Amplitude function 220 receives the I and Q digital baseband samples and provides amplitude-derived information to lookup table 230. Lookup table 230 provides a gain correction value as a function of the amplitude of the digital baseband signal. Lookup table 230 drives DAC 240, which produces an analog signal. This analog signal is smoothed at 244, and provided as the reference voltage signal V_{REF} on node 242. The gain of the MDACs is modified according to the envelope of the baseband signal to keep the gain of the entire transmit chain substantially constant with output power.

In some embodiments, the gain correction information stored in lookup table 230 corrects for nonlinearities introduced anywhere in circuit 200. For example, nonlinearities may be introduced by any combination of MDACs 250 and 252, filters 260 and 262, transconductance devices 270 and 272, mixers 280 and 282, summer 290, and power amplifier 296.

The gain correction information in lookup table 230 is stored after calibration. For example, in some embodiments, an input signal may be created digitally on nodes 212 and 214, and the output power can be detected in a conventional manner. Further, in some embodiments, output power may be detected by a receiver and receive baseband chain (not shown). Calibration may then be performed by comparing the actual output power with the expected output power, and the gain correction information may be generated. In some embodiments, calibration may be performed periodically to maintain gain correction under varying conditions.

Delay elements 222 and 224 are shown at the input of MDACs 250 and 252. The delay elements delay the input data to provide synchronization between the gain control and the input data. Delay elements 222 and 224 may be implemented in any suitable manner.

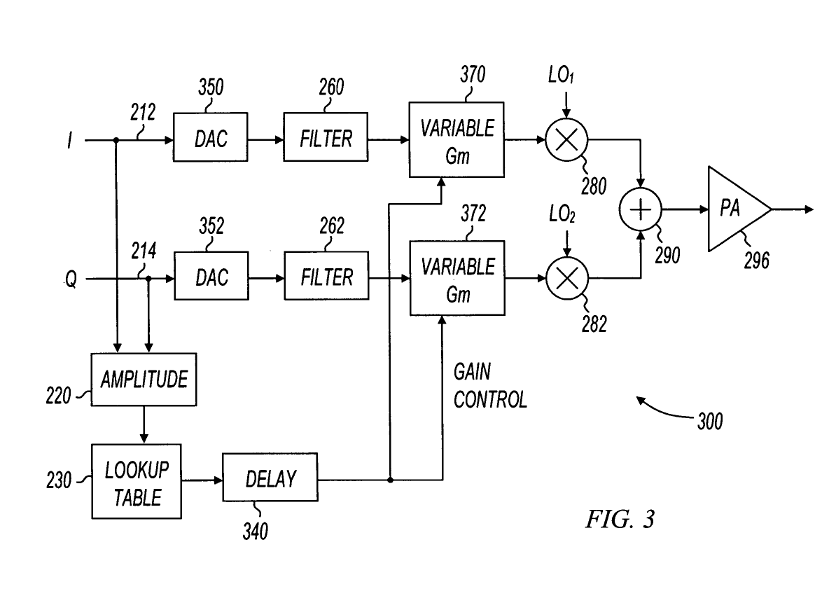

FIG. 3 shows an amplifier circuit with variable gain stages in a baseband signal path. Circuit 300 includes amplitude function 220, lookup table 230, delay element 340, digital-to-analog converters (DAC) 350 and 352, filters 260 and 262, transconductance devices 370 and 372, mixers 280 and 282, signal summer 290, and power amplifier 296.

Circuit 300 is similar to circuit 200 (FIG. 2), except that the gain of the transconductors 370 and 372 is varied instead of the gain of the baseband MDACs. The gain of transconductors 370 and 372 may be set with digitally controlled degeneration resistors, using metal oxide semiconductor field effect transistor (MOSFET) switches, or by any other suitable means. For example, in some embodiments, the gain in transconductors 370 and 372 may be controlled with an analog signal coming from a DAC with a smoothing filter as shown in FIG. 2. In these embodiments, transconductors 370 and 372 may be analog variable gain transconductors or analog multipliers.

Circuit 300 also includes DACs 350 and 352 instead of MDACs. DAC 350 converts the digital I baseband samples to an analog signal that is filtered by filter 260, and DAC 352 converts the digital Q baseband samples to an analog signal that is filtered by filter 262. Variable transconductors 370 and 372 receive the filtered analog I and Q baseband signals, and provide variable gain responsive to the gain control.

Delay circuit 340 is included to time-align the signals in the baseband data path with the signals in the amplitude correction path. In some embodiments, the delay in DACs 350 and 352 and filters 260 and 262 substantially match the delays in amplitude function 220 and lookup table 230, and delay element 340 is omitted.

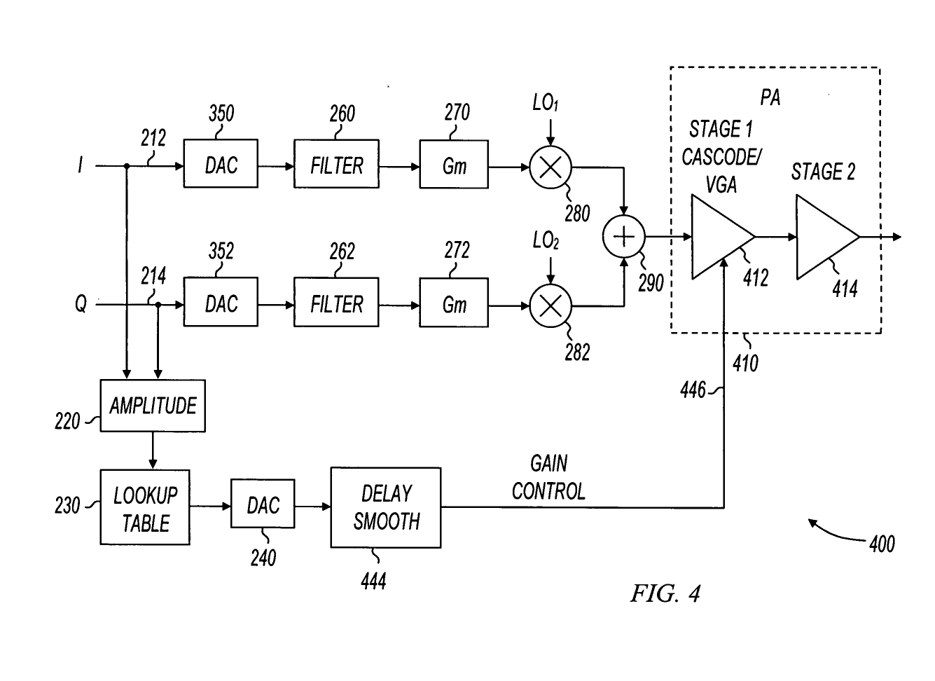

FIG. 4 shows an amplifier circuit having a variable gain radio frequency (RF) amplifier. Circuit 400 includes amplitude function 220, lookup table 230, digital-to-analog converters (DAC) 240, 350, and 352, delay element and smoothing filter 444, filters 260 and 262, transconductance devices 270 and 272, mixers 280 and 282, signal summer 290, and power amplifier 410. Power amplifier 410 includes variable gain stage 412 and second amplifier stage 414.

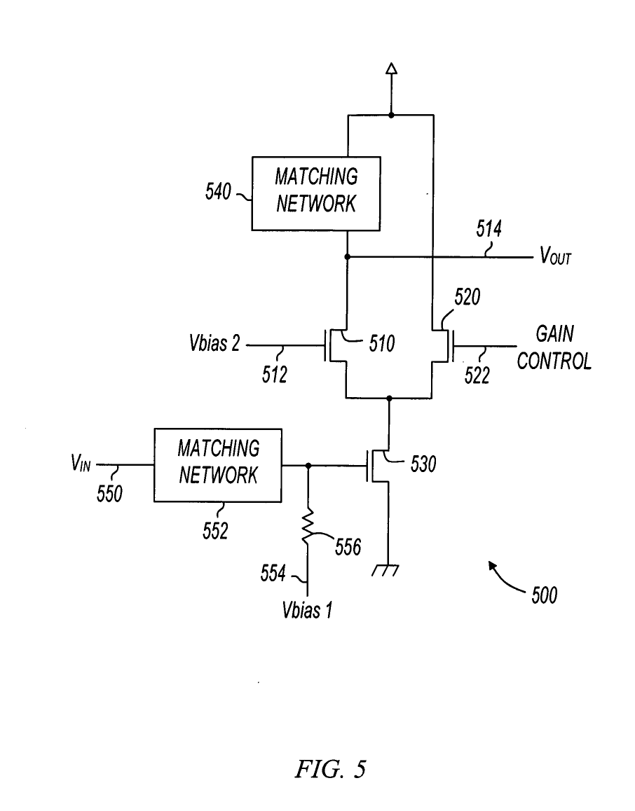

Circuit 400 is similar to circuits 200 (FIG. 2) and 300 (FIG. 3), except that the gain of variable gain stage 412 in power amplifier 410 is varied instead of the gain of the baseband MDACs or transconductance devices. In some embodiments, variable gain stage 412 may be a class A amplifier stage or other linear amplifier stage, although the various embodiments of the invention are not so limited. An example variable gain stage is shown in FIG. 5.

FIG. 5 shows a variable gain amplifier. Variable gain amplifier 500 may be utilized as a variable gain stage in a power amplifier, such as variable gain stage 412 (FIG. 4). Variable gain amplifier 500 includes transistors 510, 520, and 530, matching networks 540 and 552, and bias resistor 556. In operation, an input signal is received on node 550, and an amplified output signal is produced on node 514. Fixed bias voltages are provided on nodes 512 and 554, and a variable gain control signal is provided on node 522. The gain of amplifier 500 may be varied by modifying the amount of drain-to-source current conducted by transistors 510 and 520. For example, as the gain control signal is increased in voltage, transistor 520 conducts more current, transistor 510 conducts less current, and the gain of amplifier 500 is reduced. Also for example, as the gain control signal is decreased in voltage, transistor 520 conducts less current, transistor 510 conducts more current, and the gain of amplifier 500 is increased. Variable gain amplifier 500 is provided as an example, and the various embodiments of the present invention are not limited to the particular amplifier configuration shown in FIG. 5.

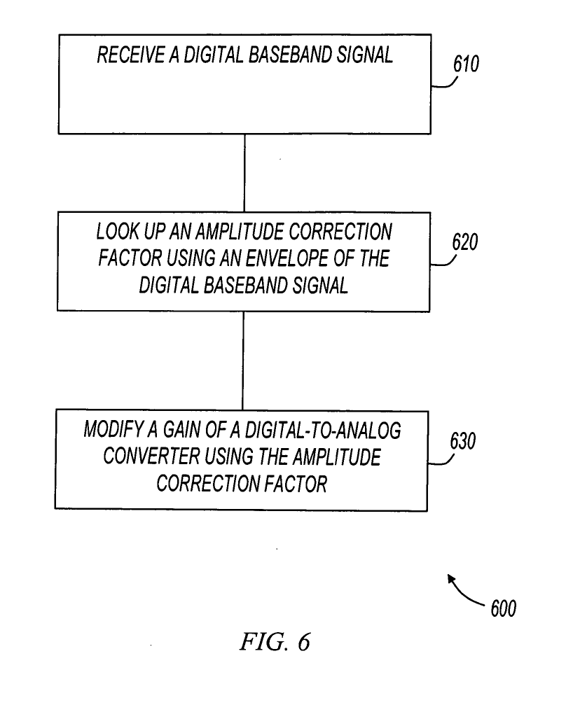

FIG. 6 shows a flowchart in accordance with various embodiments of the present invention. In some embodiments, method 600, or portions thereof, is performed by an amplifier circuit, embodiments of which are shown in previous figures. In other embodiments, method 600 is performed by an integrated circuit or an electronic system. Method 600 is not limited by the particular type of apparatus performing the method. The various actions in method 600 may be performed in the order presented, or may be performed in a different order. Further, in some embodiments, some actions listed in FIG. 6 are omitted from method 600.

Method 600 is shown beginning with block 610 in which a digital baseband signal is received. For example, a single digital baseband signal may be received in an amplifier circuit such as circuit 100 (FIG. 1). Further, in-phase and quadrature digital baseband signals may be received as shown in FIGS. 2-4.

At 620, an amplitude correction factor is looked up using an envelope of the digital baseband signal. For example, as shown in FIG. 1, an envelope detector may detect an envelope of the digital baseband signal. Also for example, an amplitude function such as amplitude function 220 (FIGS. 2, 3, 4) may determine the envelope of the digital baseband signal. Further, in some embodiments, a function of the envelope may be utilized rather than the envelope itself. The amplitude-derived correction factor may be looked up using a lookup table such as lookup table 130 (FIG. 1) or lookup table 230 (FIGS. 2, 3, 4).

At 630, the gain of a digital-to-analog converter is modified using the amplitude correction factor. For example, referring now back to FIG. 2, the results from the lookup table may be converted to an analog voltage and provided as a reference voltage for one or more multiplying digital-to-analog converters.

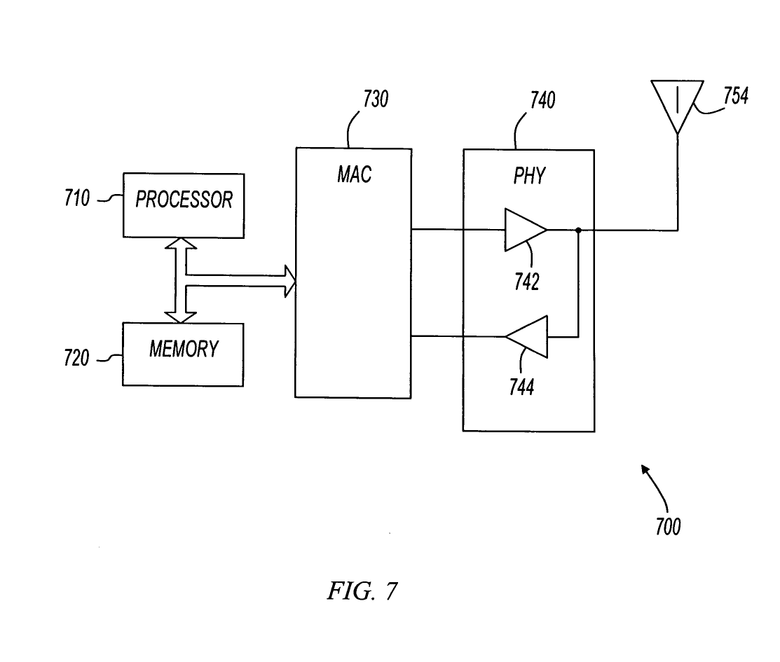

FIG. 7 shows a system diagram in accordance with various embodiments of the present invention. Electronic system 700 includes antenna 754, physical layer (PHY) 740, media access control (MAC) layer 730, processor 710, and memory 720. In operation, system 700 sends and receives signals using antenna 754, and the signals are processed by the various elements shown in FIG. 7.

Antenna 754 may include one or more antennas. For example, antenna 754 may include a single directional antenna or an omni-directional antenna. As used herein, the term omni-directional antenna refers to any antenna having a substantially uniform pattern in at least one plane. For example, in some embodiments, antenna 754 may include a single omni-directional antenna such as a dipole antenna, or a quarter wave antenna. Also for example, in some embodiments, antenna 754 may include a single directional antenna such as a parabolic dish antenna or a Yagi antenna. In still further embodiments, antenna 754 may include multiple physical antennas. For example, in some embodiments, multiple antennas are utilized for multiple-input-multiple-output (MIMO) processing or spatial-division multiple access (SDMA) processing.

Physical layer (PHY) 740 is coupled to antenna 754 to interact with other wireless devices. PHY 740 may include circuitry to support the transmission and reception of radio frequency (RF) signals. For example, as shown in FIG. 7, PHY 740 includes power amplifier (PA) 742 and low noise amplifier (LNA) 744. Power amplifier 742 may include a amplifier such as those described above with reference to FIGS. 1-5. In some embodiments, PHY 740 includes additional functional blocks to perform filtering, frequency conversion or the like.

PHY 740 may be adapted to transmit/receive and modulate/demodulate signals of various formats and at various frequencies. For example, PHY 740 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The various embodiments of the present invention are not limited in this regard.

Example systems represented by FIG. 7 include cellular phones, personal digital assistants, wireless local area network interfaces, wireless wide area network stations and subscriber units, and the like. Many other systems uses for power amplifiers exist. For example, PA 742 may be used in a desktop computer, a network bridge or router, or any other system without an antenna.

Media access control (MAC) layer 730 may be any suitable media access control layer implementation. For example, MAC 730 may be implemented in software, or hardware or any combination thereof. In some embodiments, a portion of MAC 730 may be implemented in hardware, and a portion may be implemented in software that is executed by processor 710. Further, MAC 730 may include a processor separate from processor 710.

Processor 710 may be any type of processor capable of communicating with memory 720, MAC 730, and other functional blocks (not shown). For example, processor 710 may be a microprocessor, digital signal processor (DSP), microcontroller, or the like.

Memory 720 represents an article that includes a machine readable medium. For example, memory 720 represents a random access memory (RAM), dynamic random access memory (DRAM), static random access memory (SRAM), read only memory (ROM), flash memory, or any other type of article that includes a medium readable by processor 710. Memory 720 may store instructions for performing software driven tasks. Memory 720 may also store data associated with the operation of system 700.

Although the various elements of system 700 are shown separate in FIG. 7, embodiments exist that combine the circuitry of processor 710, memory 720, MAC 730, and all or a portion of PHY 740 in a single integrated circuit. For example, MAC 730 and PA 742 may be combined together on an integrated circuit die. In some embodiments, the various elements of system 700 may be separately packaged and mounted on a common circuit board. In other embodiments, the various elements are separate integrated circuit dice packaged together, such as in a multi-chip module, and in still further embodiments, various elements are on the same integrated circuit die.

Amplifier circuits, gain correction circuits, and other embodiments of the present invention can be implemented in many ways. In some embodiments, they are implemented in integrated circuits as part of electronic systems. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, portions of amplifier circuit 200 (FIG. 2) may be represented as polygons assigned to layers of an integrated circuit.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A circuit comprising:
an input node to receive a digital baseband signal;
a lookup table to be indexed by an envelope of the baseband signal to produce a gain correction signal; and
a multiplying digital-to-analog converter to convert the digital baseband signal to an analog baseband signal, where a gain of the multiplying digital-to-analog converter is influenced by the gain correction signal.

2. The circuit of claim 1 wherein the input node includes a first input node to receive in-phase (I) baseband samples and a second input node to receive quadrature (Q) baseband samples.

3. The circuit of claim 2 wherein the lookup table is responsive to the I and Q baseband samples.

4. The circuit of claim 2 wherein the multiplying digital-to-analog converter comprises:
a first multiplying digital-to-analog converter to convert the I baseband samples to an analog I baseband signal; and
a second multiplying digital-to-analog converter to convert the Q baseband samples to an analog Q baseband signal.

5. The circuit of claim 1 further comprising circuitry to up-convert the analog baseband signal to a radio frequency (RF) signal.

6. The circuit of claim 5 further comprising an RF power amplifier to amplify the RF signal.

7. The circuit of claim 6 wherein the lookup table includes data derived, at least in part, from a gain characteristic of the power amplifier.

8. The circuit of claim 7 wherein the lookup table includes data derived from a gain characteristic exhibited between the input node and an output of the power amplifier.

9. A circuit comprising:
an input node to receive a digital baseband signal;
a lookup table coupled to be indexed by an envelope of the digital baseband signal;
a digital-to-analog converter to convert the digital baseband signal to an analog baseband signal;
a mixer to up-convert the digital baseband signal in frequency to produce a radio frequency (RF) signal; and
a variable gain stage coupled to have a gain influenced by information within the lookup table.

10. The circuit of claim 9 wherein the variable gain stage is coupled between the digital-to-analog converter and the mixer.

11. The circuit of claim 9 wherein the variable gain stage comprises a power amplifier coupled to receive the RF signal from the mixer.

12. The circuit of claim 9 wherein the input node includes two nodes to receive in-phase (I) and quadrature (Q) baseband samples, wherein the lookup table is indexed by data derived from the I and Q baseband samples.

13. The circuit of claim 12 wherein the digital-to-analog converter comprises:
a first digital-to-analog converter to convert the I baseband samples to an analog I baseband signal; and
a second digital-to-analog converter to convert the Q baseband samples to an analog Q baseband signal.

14. The circuit of claim 13 wherein the variable gain stage comprises:
a first variable gain element coupled to amplify the analog I baseband signal; and
a second variable gain element coupled to amplify the analog Q baseband signal.

15. A method comprising:
receiving a digital baseband signal;
looking up an amplitude correction factor using an envelope of the digital baseband signal; and
modify a gain of a digital-to-analog converter using the amplitude correction factor.

16. The method of claim 15 wherein receiving a digital baseband signal comprises receiving an in-phase (I) digital baseband signal and a quadrature (Q) digital baseband signal.

17. The method of claim 16 wherein modifying a gain of a digital-to-analog converter comprises:
modifying a gain of a first digital-to-analog converter to convert the I digital baseband signal; and
modifying a gain of a second digital-to-analog converter to convert the Q digital baseband signal.

18. A system comprising:
an omni-directional antenna; and
a circuit coupled to drive a signal on the antenna, the circuit comprising an input node to receive a digital baseband signal, a lookup table to be indexed by an envelope of the digital baseband signal to produce a gain correction signal, and a multiplying digital-to-analog converter to convert the digital baseband signal to an analog baseband signal, where a gain of the multiplying digital-to-analog converter is influenced by the gain correction signal.

19. The system of claim 18 wherein the input node includes a first input node to receive in-phase (I) baseband samples and a second input node to receive quadrature (Q) baseband samples.

20. The system of claim 19 wherein the multiplying digital-to-analog converter comprises:
a first multiplying digital-to-analog converter to convert the I baseband samples to an analog I baseband signals; and
a second multiplying digital-to-analog converter to convert the Q baseband samples to an analog Q baseband signal.
